(19) United States
(12) Patent Application Publication
(10) Pub. No.: US 2025/0016026 A1
(43) Pub. Date: Jan. 9, 2025

(54) COMMUNICATION DEVICE, CONTROL SYSTEM, COMMUNICATION METHOD, AND COMMUNICATION PROGRAM

(71) Applicants: Sumitomo Electric Industries, Ltd., Osaka-shi, Osaka (JP); Sumitomo Wiring Systems, Ltd., Yokkaichi-shi, Mie (JP); AutoNetworks Technologies, Ltd., Yokkaichi-shi, Mie (JP)

(72) Inventor: Yoshihisa NAGAMURA, Osaka-shi, Osaka (JP)

(73) Assignees: Sumitomo Electric Industries, Ltd., Osaka-shi, Osaka (JP); Sumitomo Wiring Systems, Ltd., Yokkaichi-shi, Mie (JP); AutoNetworks Technologies, Ltd., Yokkaichi-shi, Mie (JP)

(21) Appl. No.: 18/711,628

(22) PCT Filed: Sep. 14, 2022
(86) PCT No.: PCT/JP2022/034407

§ 371 Date: May 20, 2024

(30) Foreign Application Priority Data
Nov. 30, 2021 (JP) 2021-194700

(51) Int. Cl. H04L 12/40

(52) U.S. Cl. CPC H04L 12/4013

(57) ABSTRACT

A communication device provided outside a control target to be controlled by a control subject, includes: a communication unit configured to perform, through a network, at least one of transmission and reception of communication information to be used for control of the control target, with a communication target device provided in the control target; an acquisition unit configured to acquire measurement information based on a measurement result related to the control subject; and a communication control unit configured to perform a transmission control being a control related to transmission of the communication information by the communication unit, based on the measurement information acquired by the acquisition unit.

### TECHNICAL FIELD

The present disclosure relates to a communication device, a control system, a communication method, and a communication program.

This application claims priority on Japanese Patent Application No. 2021-194700 filed on Nov. 30, 2021, the entire content of which is incorporated herein by reference.

### BACKGROUND ART

NON PATENT LITERATURE 1 (ITU-T, “New Service and Capabilities for Network 2030: Description, Technical Gap and Performance Target Analysis”, October, 2019) states that, by around 2030, highly real-time communication will become necessary to perform smooth remote control of a control target by a control subject.

### CITATION LIST

### Non Patent Literature

NON PATENT LITERATURE 1: ITU-T, “New Service and Capabilities for Network 2030: Description, Technical Gap and Performance Target Analysis”, October, 2019

### SUMMARY OF THE INVENTION

A communication device according to the present disclosure is provided outside a control target to be controlled by a control subject, and includes: a communication unit configured to perform, through a network, at least one of transmission and reception of communication information to be used for control of the control target, with a communication target device provided in the control target; an acquisition unit configured to acquire measurement information based on a measurement result related to the control subject; and a communication control unit configured to perform a transmission control being a control related to transmission of the communication information by the communication unit, based on the measurement information acquired by the acquisition unit.

A communication device according to the present disclosure is provided in a control target to be controlled by a control subject, and includes: a communication unit configured to perform, through a network, at least one of transmission and reception of communication information to be used for control of the control target, with a communication target device provided outside the control target; an acquisition unit configured to acquire measurement information based on a measurement result related to the control target; and a communication control unit configured to perform a transmission control being a control related to transmission of the communication information by the communication unit, based on the measurement information acquired by the acquisition unit.

A control system according to the present disclosure includes: a first communication device provided outside a control target to be controlled by a control subject; and a second communication device provided in the control target. The first communication device and the second communication device exchange communication information to be used for control of the control target, through a network. The first communication device performs a transmission control being a control related to transmission of the communication information with the second communication device, based on first measurement information indicating a measurement result related to the control subject. The second communication device performs a transmission control being a control related to transmission of the communication information with the first communication device, based on second measurement information indicating a measurement result related to the control target.

A communication method according to the present disclosure is used in a communication device provided outside a control target to be controlled by a control subject, and the communication device is configured to perform, through a network, at least one of transmission and reception of communication information to be used for control of the control target, with a communication target device provided in the control target. The method includes: acquiring measurement information based on a measurement result related to the control subject; and performing a transmission control being a control related to transmission of the communication information, based on the acquired measurement information.

A communication method according to the present disclosure is used in a communication device provided in a control target to be controlled by a control subject, and the communication device is configured to perform, through a network, at least one of transmission and reception of communication information to be used for control of the control target, with a communication target device provided outside the control target. The method includes: acquiring measurement information based on a measurement result related to the control target; and performing a transmission control being a control related to transmission of the communication information, based on the acquired measurement information.

A communication program according to the present disclosure is used in a communication device provided outside a control target to be controlled by a control subject, and the program causes a computer to function as: a communication unit configured to perform, through a network, at least one of transmission and reception of communication information to be used for control of the control target, with a communication target device provided in the control target; an acquisition unit configured to acquire measurement information based on a measurement result related to the control subject; and a communication control unit configured to perform a transmission control being a control related to transmission of the communication information by the communication unit, based on the measurement information acquired by the acquisition unit.

A communication program according to the present disclosure is used in a communication device provided in a control target to be controlled by a control subject, and the program causes a computer to function as: a communication unit configured to perform, through a network, at least one of transmission and reception of communication information to be used for control of the control target, with a communication target device provided outside the control target; an acquisition unit configured to acquire measurement information based on a measurement result related to the control target; and a communication control unit configured to perform a transmission control being a control related to transmission of the communication information by the communication unit, based on the measurement information acquired by the acquisition unit.

One mode of the present disclosure can be realized not only as a communication device that includes such a characteristic processing unit, but also as a semiconductor integrated circuit that realizes a part or the entirety of the communication device.

### BRIEF DESCRIPTION OF DRAWINGS

FIG. 1 shows an example of a configuration of a control system according to an embodiment of the present disclosure.

FIG. 2 shows an example of an IP packet transmitted and received between communication devices in the control system according to the embodiment of the present disclosure.

FIG. 3 shows another example of an IP packet transmitted and received between the communication devices in the control system according to the embodiment of the present disclosure.

FIG. 4 shows an example of a configuration of a communication device according to the embodiment of the present disclosure.

FIG. 5 shows an example of a communication setting table stored in a storage unit in the communication device according to the embodiment of the present disclosure.

FIG. 6 shows an example of a configuration of a communication device according to the embodiment of the present disclosure.

FIG. 7 shows an example of a communication setting table generated by a processing unit in the communication device according to the embodiment of the present disclosure.

FIG. 8 is a flowchart showing an example of an operation procedure when the communication device according to the embodiment of the present disclosure performs transmission control.

FIG. 9 is a flowchart showing an example of an operation procedure when the communication device according to the embodiment of the present disclosure performs transmission control.

FIG. 10 is a flowchart showing another example of the operation procedure when the communication device according to the embodiment of the present disclosure performs transmission control.

FIG. 11 is a flowchart showing an example of an operation procedure when the communication device according to the embodiment of the present disclosure performs transmission control.

FIG. 12 shows an example of a sequence of transmission control in the control system according to the embodiment of the present disclosure.

FIG. 13 shows another example of the sequence of transmission control in the control system according to the embodiment of the present disclosure.

### DETAILED DESCRIPTION

A control system in which a control subject for a control target remotely controls a control target such as a vehicle or a robot, based on a measurement result of a sensor installed in the control target, has been developed.

### Problems to be Solved by the Present Disclosure

However, NON PATENT LITERATURE 1 does not propose any specific method for realizing such highly real-time communication as described above.

The present disclosure is made to solve the above problem, and an object of the present disclosure is to provide a communication device, a control system, a communication method, and a communication program capable of realizing highly real-time communication.

### Effects of the Present Disclosure

According to the present disclosure, highly real-time communication can be realized.

### DESCRIPTION OF EMBODIMENT OF THE PRESENT DISCLOSURE

First, contents of the embodiment of the present disclosure will be listed and described.

(1) A communication device according to an embodiment of the present disclosure is provided outside a control target to be controlled by a control subject, and includes: a communication unit configured to perform, through a network, at least one of transmission and reception of communication information to be used for control of the control target, with a communication target device provided in the control target; an acquisition unit configured to acquire measurement information based on a measurement result related to the control subject; and a communication control unit configured to perform a transmission control being a control related to transmission of the communication information by the communication unit, based on the measurement information acquired by the acquisition unit.

In the above configuration, since the transmission control for the communication information to be used for control of the control target is performed based on the measurement information based on the measurement result related to the control subject, the transmission control for the communication information can be precisely and flexibly performed according to the state of the control subject. Therefore, for example, by selectively or preferentially transmitting communication information that is highly important for the control subject among plural pieces of communication information, a communication delay of the communication information highly important for the control subject can be inhibited. Thus, highly real-time communication can be realized.

(2) In the above (1), the acquisition unit may acquire the measurement information indicating an area of interest being an area to which the control subject pays attention, among areas around the control target, and the transmission control may include a control for promoting transmission of the communication information related to the area of interest by the communication unit.

In the above configuration, for example, the communication information related to the area to which the control subject pays attention among the areas around the control target can be selectively or preferentially transmitted.

(3) In the above (2), the communication unit may relay the communication information received from the communication target device to another device provided on a side where the control subject is present with respect to the network, and the transmission control may include a control for promoting relay of the communication information related to the area of interest, to the other device by the communication unit.

In the above configuration, for example, the communication information related to the area to which the control subject pays attention, among the pieces of communication information received from the communication target device, can be selectively or preferentially given to the control subject.

(4) In the above (2) or (3), the transmission control may include a control for promoting transmission of the communication information related to the area of interest, to the communication device by the communication target device.

In the above configuration, for example, the communication information related to the area to which the control subject pays attention can be selectively or preferentially received from the communication target device.

(5) A communication device according to the embodiment of the present disclosure is provided in a control target to be controlled by a control subject, and includes: a communication unit configured to perform, through a network, at least one of transmission and reception of communication information to be used for control of the control target, with a communication target device provided outside the control target; an acquisition unit configured to acquire measurement information based on a measurement result related to the control target; and a communication control unit configured to perform a transmission control being a control related to transmission of the communication information by the communication unit, based on the measurement information acquired by the acquisition unit.

In the above configuration, since the transmission control for the communication information to be used for control of the control target is performed based on the measurement information based on the measurement result related to the control target, the transmission control for the communication information can be precisely and flexibly performed according to the state of the control target. Therefore, for example, by selectively or preferentially transmitting communication information that is highly important for the control subject among plural pieces of communication information, a communication delay of the communication information highly important for the control subject can be inhibited. Thus, highly real-time communication can be realized.

(6) In the above (5), the acquisition unit may acquire the measurement information indicating an area of interest being an area to which the control subject should pay attention, among areas around the control target, and the transmission control may include a control for promoting transmission of the communication information related to the area of interest, to the communication target device by the communication unit.

In the above configuration, for example, the communication information related to the area to which the control subject should pay attention, among the areas around the control target, can be selectively or preferentially transmitted to the communication target device.

(7) In the above (6), the communication unit may transmit, to the communication target device, the communication information generated by another device provided in the control target, and the transmission control may include a control for promoting transmission of the communication information related to the area of interest, to the communication target device by the communication unit itself.

In the above configuration, for example, the communication information related to the area to which the control subject should pay attention, among the pieces of communication information generated in the control target, can be selectively or preferentially transmitted to the communication target device.

(8) In the above (6) or (7), the communication unit may transmit, to the communication target device, the communication information generated by another device provided in the control target, and the transmission control may include a control for adjusting the amount of the communication information, related to the area of interest, to be generated by the other device.

In the above configuration, for example, the amount of the communication information related to the area to which the control subject should pay attention, among the pieces of communication information generated in the control target, can be increased. Therefore, a greater amount of communication information related to the area to which the control subject should pay attention can be transmitted to the communication target device.

(9) A control system according to the embodiment of the present disclosure includes: a first communication device provided outside a control target to be controlled by a control subject; and a second communication device provided in the control target. The first communication device and the second communication device exchange communication information to be used for control of the control target, through a network. The first communication device performs a transmission control being a control related to transmission of the communication information with the second communication device, based on first measurement information indicating a measurement result related to the control subject. The second communication device performs a transmission control being a control related to transmission of the communication information with the first communication device, based on second measurement information indicating a measurement result related to the control target.

In the above configuration, since the transmission control for the communication information to be used for control of the control target is performed according to the measurement information based on the measurement result related to the control subject and the measurement information based on the measurement result related to the control target, the transmission control for the communication information can be precisely and flexibly performed according to the state of the control subject and the control target. Therefore, for example, by selectively or preferentially transmitting communication information that is highly important for the control subject among plural pieces of communication information, a communication delay of the communication information highly important for the control subject can be inhibited. Thus, highly real-time communication can be realized.

(10) A communication method according to the embodiment of the present disclosure is used in a communication device provided outside a control target to be controlled by a control subject, and the communication device is configured to perform, through a network, at least one of transmission and reception of communication information to be used for control of the control target, with a communication target device provided in the control target. The method includes: acquiring measurement information based on a measurement result related to the control subject; and performing a transmission control being a control related to transmission of the communication information, based on the acquired measurement information.

In the above method, since the transmission control for the communication information to be used for control of the control target is performed based on the measurement information based on the measurement result related to the control subject, the transmission control for the communication information can be precisely and flexibly performed according to the state of the control subject. Therefore, for example, by selectively or preferentially transmitting communication information that is highly important for the control subject among plural pieces of communication information, a communication delay of the communication information highly important for the control subject can be inhibited. Thus, highly real-time communication can be realized.

(11) A communication method according to the embodiment of the present disclosure is used in a communication device provided in a control target to be controlled by a control subject, and the communication device is configured to perform, through a network, at least one of transmission and reception of communication information to be used for control of the control target, with a communication target device provided outside the control target. The method includes: acquiring measurement information based on a measurement result related to the control target; and performing a transmission control being a control related to transmission of the communication information, based on the acquired measurement information.

In the above method, since the transmission control for the communication information to be used for control of the control target is performed based on the measurement information based on the measurement result related to the control target, the transmission control for the communication information can be precisely and flexibly performed according to the state of the control target. Therefore, for example, by selectively or preferentially transmitting communication information that is highly important for the control subject among plural pieces of communication information, a communication delay of the communication information highly important for the control subject can be inhibited. Thus, highly real-time communication can be realized.

(12) A communication program according to the embodiment of the present disclosure is used in a communication device provided outside a control target to be controlled by a control subject, and the program causes a computer to function as: a communication unit configured to perform, through a network, at least one of transmission and reception of communication information to be used for control of the control target, with a communication target device provided in the control target; an acquisition unit configured to acquire measurement information based on a measurement result related to the control subject; and a communication control unit configured to perform a transmission control being a control related to transmission of the communication information by the communication unit, based on the measurement information acquired by the acquisition unit.

In the above configuration, since the transmission control for the communication information to be used for control of the control target is performed based on the measurement information based on the measurement result related to the control subject, the transmission control for the communication information can be precisely and flexibly performed according to the state of the control subject. Therefore, for example, by selectively or preferentially transmitting communication information that is highly important for the control subject among plural pieces of communication information, a communication delay of the communication information highly important for the control subject can be inhibited. Thus, highly real-time communication can be realized.

(13) A communication program according to the embodiment of the present disclosure is used in a communication device provided in a control target to be controlled by a control subject, and the program causes a computer to function as: a communication unit configured to perform, through a network, at least one of transmission and reception of communication information to be used for control of the control target, with a communication target device provided outside the control target; an acquisition unit configured to acquire measurement information based on a measurement result related to the control target; and a communication control unit configured to perform a transmission control being a control related to transmission of the communication information by the communication unit, based on the measurement information acquired by the acquisition unit.

In the above configuration, since the transmission control for the communication information to be used for control of the control target is performed based on the measurement information based on the measurement result related to the control target, the transmission control for the communication information can be precisely and flexibly performed according to the state of the control target. Therefore, for example, by selectively or preferentially transmitting communication information that is highly important for the control subject among plural pieces of communication information, a communication delay of the communication information highly important for the control subject can be inhibited. Thus, highly real-time communication can be realized.

Hereinafter, the embodiment of the present disclosure will be described with reference to the drawings. In the drawings, the same or corresponding parts are denoted by the same reference signs, and description thereof is not repeated. At least some parts of the embodiment described below can be combined together as desired.

### [Configuration and Basic Operation]

### <Control System>

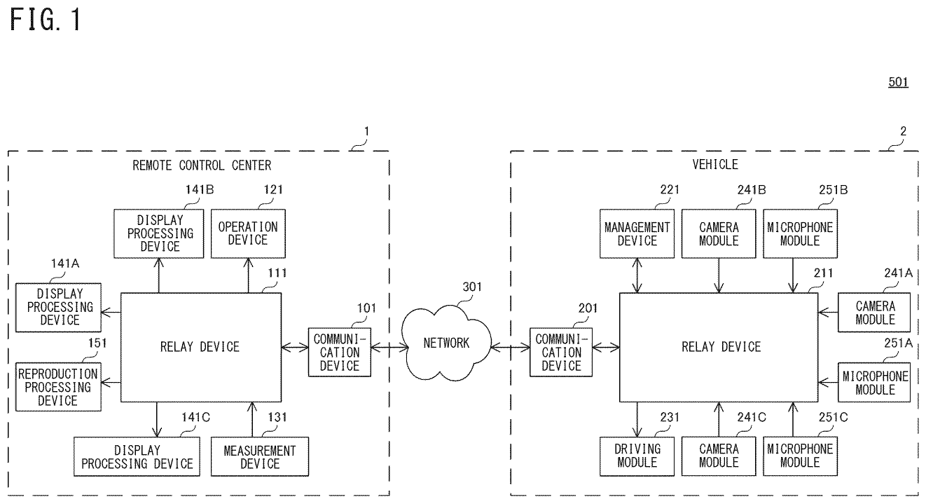

FIG. 1 shows an example of a configuration of a control system according to an embodiment of the present disclosure. With reference to FIG. 1, a control system 501 includes a communication device 101, a relay device 111, an operation device 121, a measurement device 131, display processing devices 141A, 141B, 141C, a reproduction processing device 151, a communication device 201, a relay device 211, a management device 221, a driving device 231, camera modules 241A, 241B, 241C, and microphone modules 251A, 251B, 251C. The communication device 101 is an example of a first communication device, and the communication device 201 is an example of a second communication device. The communication device 101 and the communication device 201 are examples of communication target devices. Hereinafter, each of the display processing devices 141A, 141B, 141C is also referred to as a display processing device 141, each of the camera modules 241A, 241B, 241C is also referred to as a camera module 241, and each of the microphone modules 251A, 251B, 251C is also referred to as a microphone module 251.

The communication device 101, the relay device 111, the operation device 121, the measurement device 131, the display processing device 141, and the reproduction processing device 151 are installed in a remote control center 1 located outside a vehicle 2. The communication device 101, the operation device 121, the measurement device 131, the display processing device 141, and the reproduction processing device 151 are connected to the relay device 111 via Ethernet (registered trademark) cables, for example.

The communication device 201, the relay device 211, the management device 221, the driving device 231, the camera module 241, and the microphone module 251 are installed in the vehicle 2. The communication device 201, the management device 221, the driving device 231, the camera module 241, and the microphone module 251 are connected to the relay device 211 via Ethernet cables, for example. The communication device 201, the management device 221, the driving device 231, the camera module 241, and the microphone module 251 may be connected to the relay device 211 via a bus conforming to a standard such as LIN (Local Interconnect Network), CAN (Controller Area Network) (registered trademark), CAN FD (CAN with Flexible Data rate), or MOST (Media Oriented Systems Transport).

In the remote control center 1, an operator remotely controls the vehicle 2. This operator is an example of a control subject who mainly performs the control, and the vehicle 2 is an example of a control target to be controlled. The control target of the operator is not limited to the vehicle 2, and may be a robot. That is, the communication device 201, the relay device 211, the management device 221, the driving device 231, the camera module 241, and the microphone module 251 may be installed in a robot. The control subject is not limited to the operator, and may be a robot.

The communication device 101 is used by the operator. The communication device 201 is used in the vehicle 2. The communication device 101 and the communication device 201 exchange communication information to be used for control of the vehicle 2, via a network 301. More specifically, the communication device 101 and the communication device 201 transmit and receive an IP (Internet Protocol) packet including the communication information via the network 301.

The network 301 relays the IP packet between the communication device 101 and the communication device 201 through wireless communication or wired communication. The network 301 is a WAN (Wide Area Network), for example.

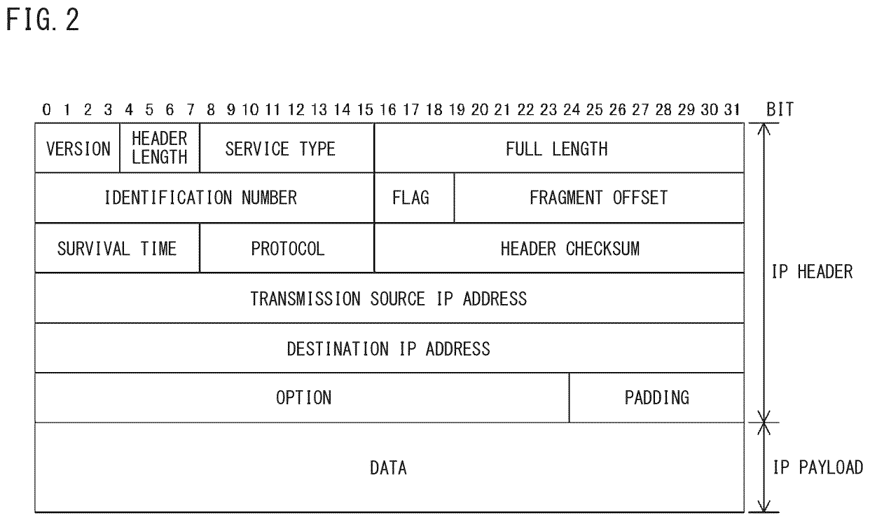

FIG. 2 shows an example of the IP packet to be transmitted and received between the communication devices of the control system according to the embodiment of the present disclosure. FIG. 2 shows an IP packet conforming to IPv4 (Internet Protocol version 4).

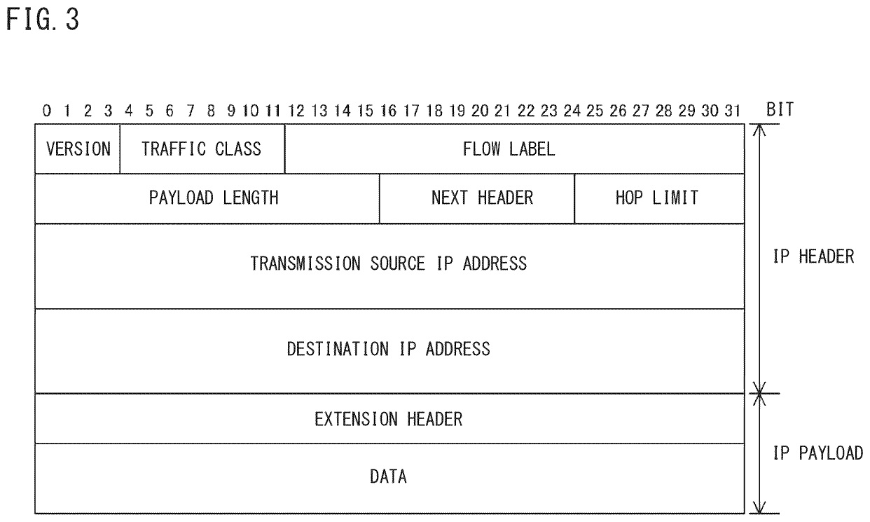

FIG. 3 shows another example of the IP packet to be transmitted and received between the communication devices of the control system according to the embodiment of the present disclosure. FIG. 3 shows an IP packet conforming to IPv6.

With reference to FIG. 2 and FIG. 3, the IP packet includes an IP header and an IP payload. The communication device 101 and the communication device 201 transmit and receive the IP packet in which the communication information is stored in the IP payload, via the network 301.

### (Image Information)

Referring back to FIG. 1, the camera module 241, for example, periodically photographs an area around the vehicle 2, and generates image information indicating the photographed image. The photographed image is an image obtained by photographing the surroundings of the vehicle 2, and is an example of a measurement result related to the vehicle 2. The image information is an example of the communication information used for control of the vehicle 2.

More specifically, the camera module 241A generates image information PA indicating a photographed image of an area forward of the vehicle 2. The camera module 241B generates image information PB indicating a photographed image of an area on the right side of the vehicle 2. The camera module 241C generates image information PC indicating a photographed image of an area on the left side of the vehicle 2.

The camera module 241 adds the generated image information to an IP packet, and transmits the IP packet to the management device 221 via the relay device 211.

In addition, the camera module 241 transmits the image information to the display processing device 141 in the remote control center 1.

More specifically, the camera module 241A generates an IP packet that includes the image information PA and is addressed to the display processing device 141A, and transmits the generated IP packet to the communication device 201 via the relay device 211. The camera module 241B generates an IP packet that includes the image information PB and is addressed to the display processing device 141B, and transmits the generated IP packet to the communication device 201 via the relay device 211. The camera module 241C generates an IP packet that includes the image information PC and is addressed to the display processing device 141C, and transmits the generated IP packet to the communication device 201 via the relay device 211.

The communication device 201 transmits the image information to the communication device 101 via the network 301. More specifically, the communication device 201 transmits the IP packet received from the camera module 241 via the relay device 211, to the communication device 101 via the network 301.

The communication device 101 transmits the IP packet received from the communication device 201 via the network 301, to the display processing device 141 via the relay device 111.

The display processing device 141 performs a process of acquiring the image information from the IP packet received from the communication device 101 via the relay device 111, and displaying the photographed image indicated by the acquired image information on a display (not shown).

For example, the display processing device 141 performs a process of displaying the photographed image indicated by the image information on three displays for simulatively displaying an image seen from the driver's seat of the vehicle 2.

More specifically, the display processing device 141A performs a process of receiving the IP packet generated by the camera module 241A, acquiring the image information PA from the received IP packet, and displaying the photographed image, of the area forward of the vehicle 2, indicated by the acquired image information PA on a display DA. The display processing device 141B performs a process of receiving the IP packet generated by the camera module 241B, acquiring the image information PB from the received IP packet, and displaying the photographed image, of the area on the right side of the vehicle 2, indicated by the acquired image information PB on a display DB disposed on the right side of the display DA as viewed from the operator. The display processing device 141C performs a process of receiving the IP packet generated by the camera module 241C, acquiring the image information PC from the received IP packet, and displaying the photographed image, of the area on the left side of the vehicle 2, indicated by the acquired image information PC on a display DC disposed on the left side of the display DA as viewed from the operator.

The display processing device 141 may be configured to perform a process of displaying the photographed image indicated by the image information on a goggle-type display, i.e., a head-mounted display, instead of performing the process of displaying the photographed image on the three displays.

The display processing device 141 may be configured to further perform a process of acquiring image information indicating a photographed image of the cabin of the vehicle, and displaying the photographed image of the cabin of the vehicle.

### (Sound Information)

The microphone module 251, for example, periodically records sound around the vehicle 2, and generates sound information indicating the recorded sound. The recorded sound is obtained by recording sound around the vehicle 2, and is an example of the measurement result related to the vehicle 2. The sound information is an example of the communication information used for control of the vehicle 2.

More specifically, the microphone module 251A generates sound information SA indicating the recorded sound in the area forward of the vehicle 2. The microphone module 251B generates sound information SB indicating the recorded sound in the area on the right side of the vehicle 2. The microphone module 251C generates sound information SC indicating the recorded sound in the area on the left side of the vehicle 2.

The microphone module 251 adds the generated sound information to an IP packet, and transmits the IP packet to the management device 221 via the relay device 211.

In addition, the microphone module 251 transmits the generated sound information to the reproduction processing device 151 in the remote control center 1.

More specifically, the microphone modules 251A, 251B, 251C generate IP packets that include the sound information SA, SB, SC, respectively, and are addressed to the reproduction processing device 151, and transmit the generated IP packets to the communication device 201 via the relay device 211.

The communication device 201 transmits the sound information to the communication device 101 via the network 301. More specifically, the communication device 201 transmits the IP packet received from the microphone module 251 via the relay device 211, to the communication device 101 via the network 301.

The communication device 101 transmits the IP packet received from the communication device 201 via the network 301, to the reproduction processing device 151 via the relay device 111.

The reproduction processing device 151 performs a process of acquiring the sound information from the IP packet received from the communication device 101 via the relay device 111, and reproducing the recorded sound indicated by the acquired sound information, by using a loudspeaker (not shown).

For example, the reproduction processing device 151 performs a process of reproducing the recorded sound indicated by the sound information, by using a directional loudspeaker for simulatively reproducing the sound heard at the driver's seat of the vehicle 2.

The reproduction processing device 151 may be configured to perform a process of reproducing the recorded sound indicated by the sound information, by using a loudspeaker mounted to a head-mounted display.

The display processing device 141 may be configured to perform a process of acquiring sound information indicating the recorded sound in the cabin of the vehicle, and reproducing the sound in the cabin.

### (Drive Control)

The operation device 121 receives an operation performed by the operator to remotely control the vehicle 2. More specifically, the operation device 121 is a device simulating the driver's seat of the vehicle 2, and includes operation mechanisms such as a steering wheel, a brake pedal, an accelerator pedal, a shift lever, a blinker lever, and a wiper lever. For example, the operation device 121 further includes: a display unit that displays details related to driving operations, such as a speedometer and a warning light; and a mechanism for propagating, to the operator, forces of vibration and rotational motion of the vehicle 2, and reactions against driving operations on the operation mechanisms such as a steering wheel, a brake pedal, and an accelerator pedal.

The operator operates the operation mechanisms of the operation device 121 while confirming the photographed image displayed on the display by the display processing device 141, and the recorded sound reproduced from the loudspeaker by the reproduction processing device 151.

Upon receiving the operation performed by the operator, the operation device 121 generates operation information indicating the details of the received operation. The operation device 121 transmits the generated operation information to the management device 221 in the vehicle 2. The operation information is an example of the communication information used for control of the vehicle 2.

More specifically, the operation device 121 generates an IP packet that includes the operation information and is addressed to the management device 221, and transmits the generated IP packet to the communication device 101 via the relay device 111.

The communication device 101 transmits the operation information to the communication device 201 via the network 301. More specifically, the communication device 101 transmits the IP packet received from the operation device 121 via the relay device 211, to the communication device 201 via the network 301.

The communication device 201 transmits the IP packet received from the communication device 101 via the network 301, to the management device 221 via the relay device 211.

The management device 221 acquires the operation information from the IP packet received from the communication device 201 via the relay device 211. Furthermore, the management device 221 acquires the image information from the IP packet received from the camera module 241 via the relay device 211. Furthermore, the management device 221 acquires the sound information from the IP packet received from the microphone module 251 via the relay device 211.

The management device 221 generates control information to be used for drive control of the vehicle 2, based on the acquired operation information, image information, and sound information. More specifically, based on the operation information, the image information, and the sound information, the management device 221 determines details of control such as a heading direction, a speed, etc., of the vehicle 2, and generates control information indicating the determined details of control. The management device 221 adds the generated control information to an IP packet, and transmits the IP packet to the driving device 231 via the relay device 211.

The driving device 231 acquires the control information from the IP packet received from the management device 221 via the relay device 211, and performs drive control for the vehicle 2, based on the acquired control information. More specifically, the driving device 231 steers, accelerates, and decelerates the vehicle 2, based on the control information, thereby controlling the heading direction and the speed of the vehicle 2. In addition, the driving device 231 further controls direction indicators, wipers, lights, etc., based on the control information.

### (Measurement Information M1)

The measurement device 131 detects a viewing area that is an area viewed by the operator, among areas around the vehicle 2 displayed on the display processing device 141. The viewing area is an example of an area of interest to which the operator pays attention.

More specifically, the measurement device 131 analyzes an image photographed by a camera for photographing the operator's face, thereby detecting the line of sight of the operator. The photographed image is an image obtained by photographing the operator, and is an example of a measurement result related to the operator.

Based on the detected line of sight of the operator, the measurement device 131 detects, as a viewing area, an area corresponding to the photographed image viewed by the operator, from among the photographed image of the area forward of the vehicle 2, the photographed image of the area on the right side of the vehicle 2, and the photographed image of the area on the left side of the vehicle 2, which are displayed on the display by the display processing device 141.

The measurement device 131, for example, periodically detects a viewing area, generates measurement information M1 indicating the detected viewing area, adds the generated measurement information M1 to an IP packet, and transmits the IP packet to the communication device 101 via the relay device 111. Alternatively, the measurement device 131 periodically detects a viewing area, and when the detected viewing area has been changed, generates measurement information M1 indicating the viewing area, adds the generated measurement information M1 to an IP packet, and transmits the IP packet to the communication device 101 via the relay device 111.

### (Measurement Information M2)

The management device 221 detects an object area that is an area in which an obstacle exists, among the areas around the vehicle 2. The object area is an example of an area of interest to which the operator should pay attention. Here, examples of the obstacle include an object that hinders traveling of the vehicle 2, an object that is likely to collide with the vehicle 2, and a railroad crossing.

More specifically, the management device 221 analyzes the photographed images indicated by the pieces of image information PA, PB, PC, respectively, to determine whether or not there is an area in which an obstacle exists, among the area forward of the vehicle 2, the area on the right side of the vehicle 2, and the area on the left side of the vehicle 2.

When the management device 221 has determined that there is an obstacle in at least one of the area forward of the vehicle 2, the area on the right side of the vehicle 2, and the area on the left side of the vehicle 2, the management device 221 detects the area in which the obstacle exists, as an object area.

For example, upon determining that there is an obstacle in the area around the vehicle 2, the management device 221 generates measurement information M2 indicating the object area, adds the generated measurement information M2 to an IP packet, and transmits the IP packet to the communication device 201 via the relay device 211.

The management device 221 may be configured to detect an object area by analyzing the recorded sounds indicated by the pieces of sound information SA, SB, SC, respectively. Alternatively, the management device 221 may be configured to detect an object area, based on a detection result of LiDAR (Light Detection and Ranging) or a millimeter wave radar capable of detecting an object in an area around the vehicle 2.

### <Communication Device>

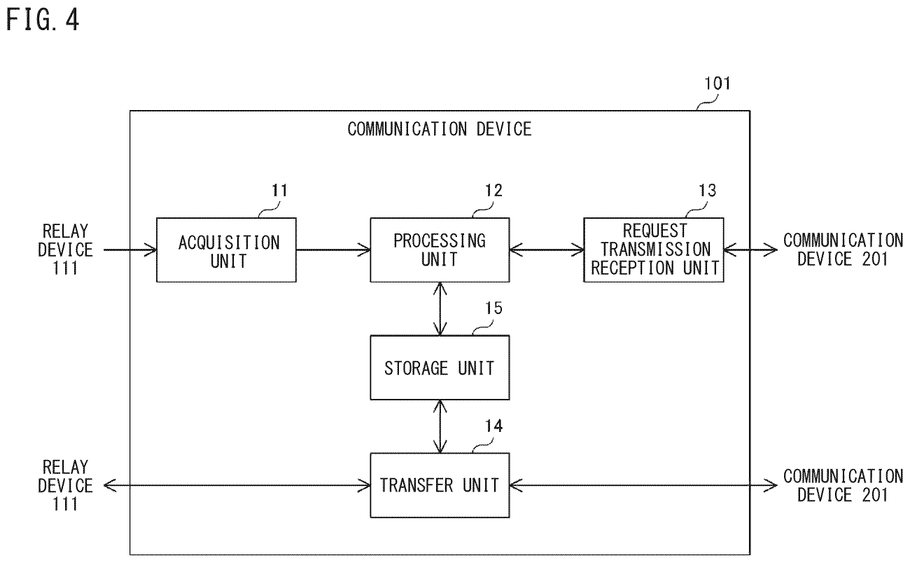

FIG. 4 shows an example of a configuration of a communication device according to the embodiment of the present disclosure. FIG. 4 shows the configuration of the communication device 101 in the remote control center 1.

With reference to FIG. 4, the communication device 101 includes an acquisition unit 11, a processing unit 12, a request transmission reception unit 13, a transfer unit 14, and a storage unit 15. The processing unit 12 is an example of a communication control unit. The transfer unit 14 is an example of a communication unit. Some or all of the acquisition unit 11, the processing unit 12, the request transmission reception unit 13, and the transfer unit 14 are realized by, for example, processing circuitry including one or more processors. The storage unit 15 is, for example, a non-volatile memory included in the processing circuit.

The transfer unit 14 performs transmission and reception of the communication information used for control of the vehicle 2, with the communication device 201 in the vehicle 2 via the network 301. For example, the transfer unit 14 relays the image information and the sound information received from the communication device 201 to the relay device 111 on the operator side with respect to the network 301.

More specifically, the transfer unit 14 receives the IP packet including the operation information from the relay device 111, and transmits the received IP packet to the communication device 201 via the network 301. In addition, the transfer unit 14 receives the IP packet including the image information from the communication device 201 via the network 301, and transmits the received IP packet to the relay device 111. Moreover, the transfer unit 14 receives the IP packet including the sound information from the communication device 201 via the network 301, and transmits the received IP packet to the relay device 111.

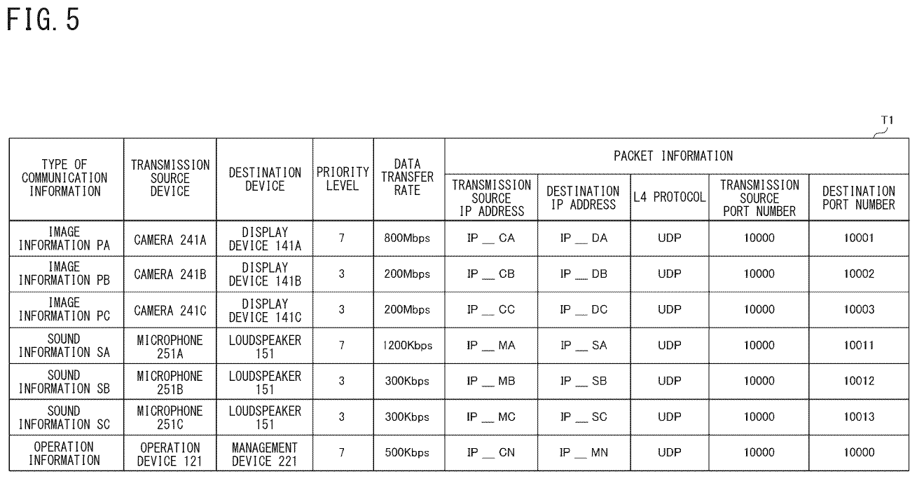

FIG. 5 shows an example of a communication setting table stored in the storage unit in the communication device according to the embodiment of the present disclosure. With reference to FIG. 5, the storage unit 15 has, stored therein, a communication setting table T indicating the correspondence relationship between the type of communication information included in an IP packet transmitted and received by the transfer unit 14, a transmission source device of the IP packet, a destination device of the IP packet, the priority level of the communication information, the data transfer rate of the communication information, and packet information of the IP packet. The packet information includes a transmission source IP address, a destination IP address, an L4 (layer 4) protocol, a transmission source port number, and a destination port number. The priority levels of the communication information are represented by values from zero to 7. The larger the value is, the higher the priority level is.

For example, the transfer unit 14 performs communication according to the communication setting table T1 stored in the storage unit 15.

More specifically, upon receiving an IP packet from the relay device 111 or the communication device 201, the transfer unit 14 acquires packet information from the received IP packet. Then, the transfer unit 14 acquires, from the communication setting table T1 stored in the storage unit 15, the priority level and the data transfer rate corresponding to the acquired packet information.

The transfer unit 14 stores the value of the acquired priority level in the IP header of the received IP packet. Specifically, when the received IP packet is an IP packet conforming to IPv4, the transfer unit 14 stores the value of the priority level in the service type field of the IP header. Meanwhile, when the received IP packet is an IP packet conforming to IPv6, the transfer unit 14 stores the value of the priority level in the traffic class field of the IP header.

Then, the transfer unit 14 determines a transmission timing of the IP packet according to the value of the data transfer rate and the priority level of the IP packet which are acquired from the communication setting table T1. More specifically, the transfer unit 14 determines the transmission timing of the IP packet such that the data transfer rate of the communication information becomes equal to or lower than the value of the data transfer rate acquired from the communication setting table T1. The transfer unit 14 transmits the IP packet to the relay device 111 or the communication device 101, according to the determined transmission timing and the priority level.

The transfer unit 14 may be configured to process the communication information included in the IP packet, according to the value of the data transfer rate acquired from the communication setting table T1. More specifically, the transfer unit 14 processes the communication information included in the IP packet such that the data transfer rate of the communication information becomes equal to or lower than the data transfer rate acquired from the communication setting table T1, and transmits the IP packet. Specifically, the transfer unit 14 performs, as processing on the communication information, at least one of: reducing the resolution and frame rate of the image information; changing the image information compression method; reducing the sampling frequency of the sound information; and changing the sound information compression method.

The IP packet is relayed to the destination device according to the value of the priority level stored in the IP header, and is processed in the destination device according to the value of the priority level. Therefore, the IP packet higher in priority level is preferentially transmitted to the destination device and preferentially processed by the destination device, compared to the IP packet lower in priority level. If the IP packet needs to be discarded in any device due to buffer overflow or the like, the IP packet lower in priority level is preferentially discarded compared to the IP packet higher in priority level.

Referring back to FIG. 4, the acquisition unit 11 acquires the measurement information M1 based on the measurement result related to the operator. For example, the acquisition unit 11 acquires the measurement information M1 indicating the viewing area determined based on the measurement result related to the operator.

More specifically, the acquisition unit 11 receives the IP packet including the measurement information M1 from the measurement device 131 via the relay device 111, and acquires the measurement information M1 from the received IP packet. The acquisition unit 11 outputs the acquired measurement information M1 to the processing unit 12.

The processing unit 12 performs a transmission control that is a control related to transmission of the communication information by the transfer unit 14, based on the measurement information M1 acquired by the acquisition unit 11.

More specifically, based on the measurement information M1, the processing unit 12 controls at least one of the priority level of the IP packet transmitted and received by the transfer unit 14, and the data transfer rate of the communication information included in the IP packet. The transmission control by the processing unit 12 will be described later in detail.

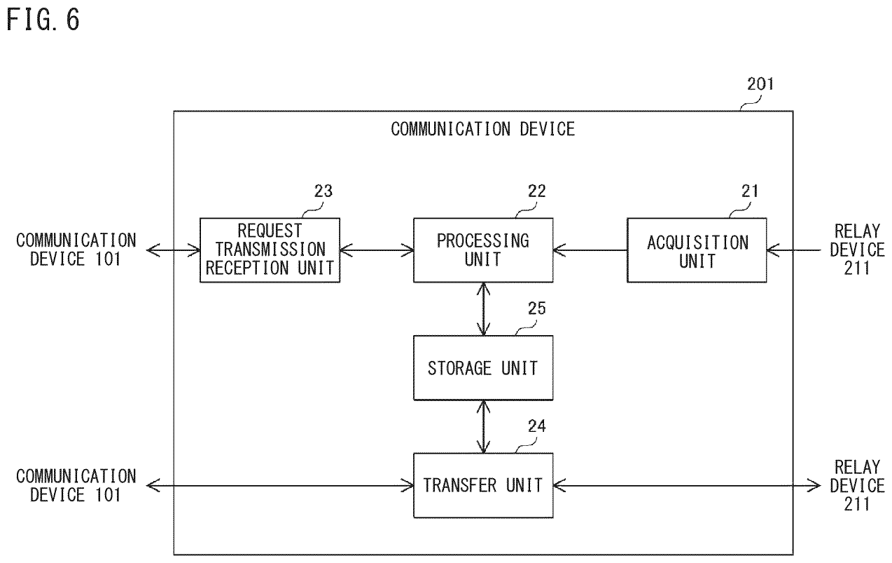

FIG. 6 shows an example of the configuration of the communication device according to the embodiment of the present disclosure. FIG. 6 shows the configuration of the communication device 201 in the vehicle 2.

With reference to FIG. 6, the communication device 201 includes an acquisition unit 21, a processing unit 22, a request transmission reception unit 23, a transfer unit 24, and a storage unit 25. The processing unit 22 is an example of the communication control unit. The transfer unit 24 is an example of the communication unit. Some or all of the acquisition unit 21, the processing unit 22, the request transmission reception unit 23, and the transfer unit 24 are realized by, for example, processing circuitry including one or more processors. The storage unit 25 is, for example, a non-volatile memory included in the processing circuit. The storage unit 25 has, stored therein, the communication setting table T1 as in the storage unit 15.

The transfer unit 24 performs transmission and reception of the communication information to be used for control of the vehicle 2, via the network 301, with the communication device 101 located on the operator side with respect to the network 301. For example, the transfer unit 24 transmits the image information generated by the camera module 241 and the sound information generated by the microphone module 251 in the vehicle 2 to the communication device 101 via the network 301.

More specifically, the transfer unit 24 receives the IP packet including the image information from the relay device 211, and transmits the received IP packet to the communication device 101 via the network 301. In addition, the transfer unit 24 receives the IP packet including the sound information from the relay device 211, and transmits the received IP packet to the communication device 101 via the network 301. In addition, the transfer unit 24 receives the IP packet including the operation information from the communication device 101 via the network 301, and transmits the received IP packet to the relay device 211.

For example, like the transfer unit 14, the transfer unit 24 performs communication according to the communication setting table T1 stored in the storage unit 25.

The acquisition unit 21 acquires the measurement information M2 based on the measurement result related to the vehicle 2. For example, the acquisition unit 21 acquires the measurement information M2 that is determined based on the measurement result related to the vehicle 2 and indicates the object area out of the area around the vehicle 2.

More specifically, the acquisition unit 21 receives the IP packet including the measurement information M2 from the management device 221 via the relay device 211, and acquires the measurement information M2 from the received IP packet. The acquisition unit 21 outputs the acquired measurement information M2 to the processing unit 22.

Based on the measurement information M2 acquired by the acquisition unit 21, the processing unit 22 performs a transmission control that is a control related to transmission of the communication information by the transfer unit 24.

More specifically, based on the measurement information M2, the processing unit 22 controls at least one of the priority level of the IP packet transmitted and received by the transfer unit 24, and the data transfer rate of the communication information included in the IP packet. The transmission control by the processing unit 22 will be described later in detail.

### Specific Example 1 of Transmission Control

As an example, an operator is operating the operation mechanisms of the operation device 121 while viewing the photographed image, of the area forward of the vehicle 2, displayed on the display by the display processing device 141.

In this case, based on the detection result of the line of sight of the operator, the measurement device 131 detects the area forward of the vehicle 2 as a viewing area, adds the measurement information M1 indicating the detected viewing area to an IP packet, and transmits the IP packet to the communication device 101 via the relay device 111.

Referring back to FIG. 4, the acquisition unit 11 in the communication device 101 receives the IP packet including the measurement information M1 from the measurement device 131 via the relay device 111, acquires the measurement information M1 from the received IP packet, and outputs the measurement information M1 to the processing unit 12.

Upon receiving the measurement information M1, the processing unit 12 determines whether or not a transmission control is necessary, i.e., whether or not update of the communication setting table T1 in the storage unit 15 is necessary, based on the received measurement information M1.

More specifically, the processing unit 12 determines that the operator pays attention to the area forward of the vehicle 2, based on the viewing area indicated by the measurement information M1. Then, the processing unit 12 determines that update of the communication setting table T1 is not necessary because, in the communication setting table T1, the image information PA indicating the photographed image of the area forward of the vehicle 2 being the viewing area and the sound information SA indicating the recorded sound in the area forward of the vehicle 2 being the viewing area, are higher in priority level and larger in data transfer rate, compared to the other image information and the other sound information.

Next, it is assumed that the operator shifts his/her line of sight to the photographed image, of the area on the right side of the vehicle 2, displayed on the display by the display processing device 141.

In this case, based on the detection result of the line of sight of the operator, the measurement device 131 detects the area on the right side of the vehicle 2 as a viewing area, adds the measurement information M1 indicating the detected viewing area to an IP packet, and transmits the IP packet to the communication device 101 via the relay device 111.

The acquisition unit 11 in the communication device 101 receives the IP packet including the measurement information M1 from the measurement device 131 via the relay device 111, acquires the measurement information M1 from the received IP packet, and outputs the measurement information M1 to the processing unit 12.

Upon receiving the measurement information M1, the processing unit 12 determines whether or not a transmission control is necessary, i.e., whether or not update of the communication setting table T1 in the storage unit 15 is necessary, based on the received measurement information M1.

More specifically, the processing unit 12 determines that the operator pays attention to the area on the right side of the vehicle 2, based on the viewing area indicated by the measurement information M1. Then, the processing unit 12 determines that update of the communication setting table T1 is necessary because, in the communication setting table T1, the image information PB indicating the photographed image of the area on the right side of the vehicle 2 being the viewing area and the sound information SB indicating the recorded sound in the area on the right side of the vehicle 2 being the viewing area, are lower in priority level and smaller in data transfer rate, compared to the image information PA and the sound information SA.

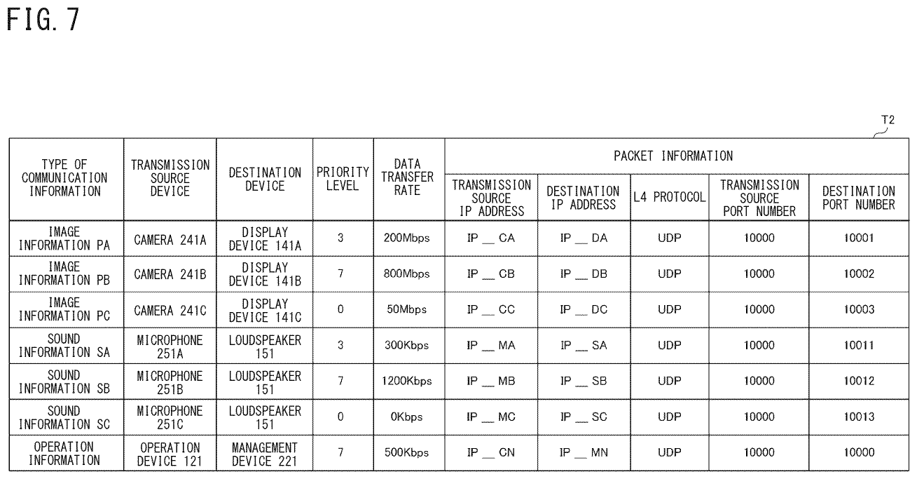

FIG. 7 shows an example of a communication setting table generated by the processing unit in the communication device according to the embodiment of the present disclosure.

With reference to FIG. 7, the transmission control by the processing unit 12 includes a control for promoting transmission of the communication information related to the viewing area by the transfer unit 14.

For example, the transmission control by the processing unit 12 includes a control for promoting relay of the communication information related to the viewing area to the relay device 111 by the transfer unit 14.

More specifically, the processing unit 12 determines to change the priority level of the image information PB from “3” to “7”, change the data transfer rate of the image information PB from “200 Mbps” to “800 Mbps”, change the priority level of the sound information SB from “3” to “7”, and change the data transfer rate of the sound information SB from “300 Kbps” to “1200 Kbps”.

Furthermore, for example, the transmission control by the processing unit 12 includes a control for inhibiting relay of the communication information related to an area other than the viewing area to the relay device 111 by the transfer unit 14.

More specifically, the processing unit 12 determines to change the priority level of the image information PA from “7” to “3”, change the data transfer rate of the image information PA from “800 Mbps” to “200 Mbps”, change the priority level of the sound information SA from “7” to “3”, and change the data transfer rate of the sound information SA from “1200 Kbps” to “300 Kbps”. In addition, the processing unit 12 determines to change the priority level of the image information PC from “3” to “0”, change the data transfer rate of the image information PC from “200 Mbps” to “50 Mbps”, change the priority level of the sound information SC from “3” to “0”, and change the data transfer rate of the sound information SC from “300 Kbps” to “0 Kbps”.

Then, the processing unit 12 generates a communication setting table T2 in which the details of the determined changes are reflected, and updates the communication setting table T1 in the storage unit 15 to the generated communication setting table T2.

The transfer unit 14 in the communication device 101 performs communication according to the updated communication setting table T2 in the storage unit 15. Thus, relay of the communication information related to the viewing area to the relay device 111 by the transfer unit 14 is promoted, and relay of the communication information related to the area other than the viewing area to the relay device 111 by the transfer unit 14 is inhibited.

Referring back to the FIG. 4, for example, the transmission control by the processing unit 12 includes a control for promoting transmission of the communication information related to the viewing area to the communication device 101 by the communication device 201. As an example, the processing unit 12 transmits request information R1 indicating that the transmission control should be performed, to the communication device 201. Meanwhile, for example, the processing unit 12 does not transmit the measurement information M1 to the communication device 201.

More specifically, the processing unit 12 generates the request information R1 including the communication setting table T2, and outputs the generated request information R1 to the request transmission reception unit 13.

The request transmission reception unit 13 receives the request information R1 from the processing unit 12, generates an IP packet including the received request information R1, and transmits the generated IP packet to the communication device 201 via the network 301.

Referring back to FIG. 6, the request transmission reception unit 23 in the communication device 201 receives the IP packet from the communication device 101 via the network 301, and acquires the request information R1 from the received IP packet. The request transmission reception unit 23 outputs the acquired request information R1 to the processing unit 22.

The processing unit 22 receives the request information R1 from the request transmission reception unit 23, and acquires the communication setting table T2 from the received request information R1. The processing unit 22 determines that the communication setting table T1 in the storage unit 25 needs to be updated because the acquired communication setting table T2 is different from the communication setting table T1 in the storage unit 25, and updates the communication setting table T1 in the storage unit 25 to the communication setting table T2.

The transfer unit 24 in the communication device 201 performs communication according to the updated communication setting table T2 in the storage unit 25. Thus, transmission of the communication information related to the viewing area to the communication device 101 by the transfer unit 24 is promoted, and transmission of the communication information related to the area other than the viewing area to the communication device 101 by the transfer unit 24 is inhibited.

For example, the processing unit 22 adjusts the amount of the communication information, related to the viewing area, to be generated by the camera module 241 and the microphone module 251.

More specifically, regarding the communication information in which the priority level and the data transfer rate have been changed due to the update of the communication setting table T1 to the communication setting table T2, the processing unit 22 generates adjustment information including the changed priority level and data transfer rate. The processing unit 22 adds the generated adjustment information to an IP packet, and transmits the IP packet to the device that is the transmission source of the communication information, via the relay device 211.

The camera module 241 and the microphone module 251 each acquire the adjustment information from the IP packet received from the communication device 201 via the relay device 211, and adjust the amount of the communication information to be generated, based on the acquired adjustment information.

More specifically, the camera module 241B acquires the adjustment information from the IP packet received from the communication device 201 via the relay device 211, and increases the amount of the image information PB to be generated, based on the acquired adjustment information. Meanwhile, the camera modules 241A, 241C each acquire the adjustment information from the IP packet received from the communication device 201 via the relay device 211, and decrease the amounts of the image information PA, PC to be generated, based on the acquired adjustment information.

The microphone module 251B acquires the adjustment information from the TP packet received from the communication device 201 via the relay device 211, and increases the amount of the sound information SB to be generated, based on the acquired adjustment information. Meanwhile, the microphone modules 251A, 251C each acquire the adjustment information from the IP packet received from the communication device 201 via the relay device 211, and decrease the amounts of the sound information SA, SC to be generated, based on the acquired adjustment information.

The camera module 241 and the microphone module 251 perform, as adjustment of the amount of the communication information, at least one of: reducing the resolution and frame rate of the image information; changing the image information compression method; reducing the sampling frequency of the sound information; and changing the sound information compression method.

### Specific Example 2 of Transmission Control

As an example, an operator is operating the operation mechanisms of the operation device 121 while viewing the photographed image, of the area forward of the vehicle 2, displayed on the display by the display processing device 141.

For example, based on a determination result as to whether or not an obstacle exists, the management device 221 detects the area on the right side of the vehicle 2 as an object area, adds the measurement information M2 indicating the detected object area to an IP packet, and transmits the IP packet to the communication device 201 via the relay device 211.

Referring back to FIG. 6, the acquisition unit 21 in the communication device 201 receives the IP packet including the measurement information M2 from the management device 221 via the relay device 211, acquires the measurement information M2 from the received IP packet, and outputs the measurement information M2 to the processing unit 22.

Upon receiving the measurement information M2, the processing unit 22 determines whether or not a transmission control is necessary, i.e., whether or not update of the communication setting table T1 in the storage unit 25 is necessary, based on the received measurement information M2.

More specifically, based on the object area indicated by the measurement information M2, the processing unit 22 determines that the operator should pay attention to the area on the right side of the vehicle 2. Then, the processing unit 22 determines that the communication setting table T1 needs to be updated because, in the communication setting table T1, the image information PB indicating the photographed image of the area on the right side of the vehicle 2 being the object area and the sound information SB indicating the recorded sound in the area on the right side of the vehicle 2 being the object area, are lower in priority level and smaller in data transfer rate, compared to the image information PA and the sound information SA.

The transmission control by the processing unit 22 includes a control for promoting transmission of the communication information related to the object area to the communication device 101 by the transfer unit 24.

For example, the transmission control by the processing unit 22 includes a control for promoting transmission of the communication information related to the object area to the communication device 101 by the transfer unit 24 itself.

More specifically, the processing unit 22 determines to change the priority level of the image information PB from “3” to “7”, change the data transfer rate of the image information PB from “200 Mbps” to “800 Mbps”, change the priority level of the sound information SB from “3” to “7”, and change the data transfer rate of the sound information SB from “300 Kbps” to “1200 Kbps”.

In addition, for example, the transmission control by the processing unit 22 includes a control for inhibiting transmission of the communication information related to an area other than the object area to the communication device 101 by the transfer unit 24 itself.

More specifically, the processing unit 22 determines to change the priority level of the image information PA from “7” to “3”, change the data transfer rate of the image information PA from “800 Mbps” to “200 Mbps”, change the priority level of the sound information SA from “7” to “3”, and change the data transfer rate of the sound information SA from “1200 Kbps” to “300 Kbps”. Furthermore, the processing unit 22 determines to change the priority level of the image information PC from “3” to “0”, change the data transfer rate of the image information PC from “200 Mbps” to “50 Mbps”, change the priority level of the sound information SC from “3” to “0”, and change the data transfer rate of the sound information SC from “300 Kbps” to “0 Kbps”.

Then, the processing unit 22 generates a communication setting table T2 in which the details of the determined changes are reflected, and updates the communication setting table T1 in the storage unit 25 to the generated communication setting table T2.

The transfer unit 24 in the communication device 201 performs communication according to the updated communication setting table T2 in the storage unit 25. Thus, transmission of the communication information related to the object area to the communication device 101 by the transfer unit 24 itself is promoted, and transmission of the communication information related to the area other than the object area to the communication device 101 by the transfer unit 24 itself is inhibited.

Referring back to FIG. 6, for example, the transmission control by the processing unit 22 includes a control for adjusting the amount of the communication information, related to the object area, to be generated by the camera module 241 and the microphone module 251.

More specifically, regarding the communication information in which the priority level and the data transfer rate have been changed due to the update of the communication setting table T1 to the communication setting table T2, the processing unit 22 generates adjustment information including the changed priority level and data transfer rate. The processing unit 22 adds the generated adjustment information to an IP packet, and transmits the IP packet to the device that is the transmission source of the communication information, via the relay device 211.

The camera module 241 and the microphone module 251 each acquire the adjustment information from the IP packet received from the communication device 201 via the relay device 211, and adjust the amounts of the communication information to be generated, based on the acquired adjustment information.

For example, the transmission control by the processing unit 22 includes a control for promoting relay of the communication information related to the object area to the relay device 111 by the communication device 101. As an example, the processing unit 22 transmits request information R2 indicating that the transmission control should be performed, to the communication device 101. Meanwhile, for example, the processing unit 22 does not transmit the measurement information M2 to the communication device 101. More specifically, the processing unit 22 generates the request information R2 including the communication setting table T2, and outputs the generated request information R2 to the request transmission reception unit 23.

Upon receiving the request information R2 from the processing unit 22, the request transmission reception unit 23 generates an IP packet including the received request information R2, and transmits the generated IP packet to the communication device 101 via the network 301.

Referring back to FIG. 4, the request transmission reception unit 13 in the communication device 101 receives the IP packet from the communication device 201 via the network 301, and acquires the request information R2 from the received IP packet. The request transmission reception unit 13 outputs the acquired request information R2 to the processing unit 12.

The processing unit 12 receives the request information R2 from the request transmission reception unit 13, and acquires the communication setting table T2 from the received request information R2. The processing unit 12 determines that the communication setting table T1 in the storage unit 15 should be updated because the acquired communication setting table T2 is different from the communication setting table T1 in the storage unit 15, and updates the communication setting table T1 in the storage unit 15 to the communication setting table T2.

The transfer unit 14 in the communication device 101 performs communication according to the updated communication setting table T2 in the storage unit 15. Thus, relay of the communication information related to the object area to the relay device 111 by the transfer unit 14 is promoted, and relay of the communication information related to the area other than the object area to the relay device 111 by the transfer unit 14 is inhibited.

### Modification 1

The acquisition unit 11 in the communication device 101 may be configured to be capable of acquiring measurement information M1A based on a measurement result of a gyro sensor attached to the head of the operator, instead of or in addition to the measurement information M1 based on the photographed image of the operator's face. More specifically, the gyro sensor measures the angle of the operator's head, the angular velocity of the operator's head, or the angular acceleration of the operator's head. The acquisition unit 11 acquires the measurement information M1A that is obtained by analyzing the measurement result of the gyro sensor and indicates the direction of the operator's face. The measurement result of the gyro sensor is an example of the measurement result related to the operator.

The acquisition unit 11 may be configured to be capable of acquiring measurement information M1B based on a measurement result of a gyro sensor attached to a finger of the operator, instead of or in addition to the measurement information M1. More specifically, the gyro sensor measures the angle of the operator's finger, the angular velocity of the operator's finger, or the angular acceleration of the operator's finger. The acquisition unit 11 acquires the measurement information M1B that is obtained by analyzing the measurement result of the gyro sensor and indicates the direction pointed by the operator's finger. The measurement result of the gyro sensor is an example of the measurement result related to the operator.

The acquisition unit 11 may be configured to be capable of acquiring measurement information M1C based on an image photographed by a camera that photographs a finger of the operator, instead of or in addition to the measurement information M1. More specifically, the acquisition unit 11 acquires the measurement information M1C that is obtained by analyzing the image photographed by the camera and indicates the direction pointed by the operator's finger. The image photographed by the camera is an image obtained by photographing the operator, and is an example of the measurement result related to the operator.

The acquisition unit 11 may be configured to be capable of acquiring measurement information M1D based on a measurement result of a microphone disposed near the operator, instead of or in addition to the measurement information M1. More specifically, the microphone measures sound such as a monologue uttered by the operator. The acquisition unit 11 acquires the measurement information M1D that is obtained by analyzing the measurement result of the microphone and indicates an area of interest to which the operator pays attention. The measurement result of the microphone is an example of the measurement result related to the operator.

The acquisition unit 11 may be configured to be capable of acquiring measurement information M1E based on a measurement result of other measurement equipment, instead of or in addition to the measurement information M1. More specifically, the measurement equipment measures biological information indicating the motion or the state of the operator. The acquisition unit 11 acquires the measurement information M1E that is obtained by analyzing the measurement result of the measurement equipment and indicates an area of interest to which the operator pays attention. The measurement result of the measurement equipment is an example of the measurement result related to the operator.

For example, when the acquisition unit 11 is capable of acquiring a plurality of kinds of measurement information, the processing unit 12 designates, to the acquisition unit 11, measurement information to be outputted to the processing unit 12 among the plurality of kinds of measurement information.

The acquisition unit 11 acquires the measurement information designated by the processing unit 12, and outputs the measurement information to the processing unit 12.

### Modification 2

The acquisition unit 21 in the communication device 201 may be configured to be capable of acquiring measurement information M2A based on a measurement result of a vibration sensor attached to the vehicle 2, instead of or in addition to the measurement information M2 based on the photographed image and recorded sound around the vehicle 2. More specifically, the acquisition unit 21 acquires the measurement information M2A that is obtained by analyzing the measurement result of the vibration sensor and indicates an area where the state of the road surface is not good. The measurement result of the vibration sensor is an example of the measurement result related to the vehicle 2.

The acquisition unit 21 may be configured to be capable of acquiring measurement information M2B based on a measurement result of a gyro sensor attached to the vehicle 2, instead of or in addition to the measurement information M2. More specifically, the gyro sensor measures the angle of the vehicle 2, the angular velocity of the vehicle 2, or the angular acceleration of the vehicle 2. The acquisition unit 21 acquires the measurement information M2B that is obtained by analyzing the measurement result of the gyro sensor and indicates the direction of the vehicle 2. The measurement result of the gyro sensor is an example of the measurement result related to the vehicle 2.

The acquisition unit 21 may be configured to be capable of acquiring measurement information M2C based on a measurement result of an acceleration sensor or a speed sensor attached to the vehicle 2, instead of or in addition to the measurement information M2. More specifically, the acceleration sensor measures the gravitational acceleration of the vehicle 2. The speed sensor measures the speed of the vehicle 2. The acquisition unit 21 acquires the measurement information M2C that is obtained by analyzing the measurement result of the acceleration sensor or the speed sensor and indicates an area of interest to which the operator should pay attention. The measurement results of the acceleration sensor and the speed sensor are examples of the measurement result related to the vehicle 2.

The acquisition unit 21 may be configured to be capable of acquiring measurement information M2D based on an image photographed by a camera that photographs the cabin of the vehicle 2, instead of or in addition to the measurement information M2. More specifically, the acquisition unit 21 acquires the measurement information M2D that is obtained by analyzing the image photographed by the camera and indicates an area of interest to which the operator should pay attention. The image photographed by the camera is an image obtained by photographing the vehicle 2, and is an example of the measurement result related to the vehicle 2.

The acquisition unit 21 may be configured to be capable of acquiring measurement information M2E based on a measurement result of a microphone provided inside the cabin of the vehicle 2, instead of or in addition to the measurement information M2. More specifically, the microphone measures the sound inside the cabin of the vehicle. The acquisition unit 21 acquires the measurement information M1E that is obtained by analyzing the measurement result of the microphone and indicates an area of interest to which the operator should pay attention. The measurement result of the microphone is an example of the measurement result related to the vehicle 2.

For example, when the acquisition unit 21 is capable of acquiring a plurality of kinds of measurement information, the processing unit 22 designates, to the acquisition unit 21, measurement information to be outputted to the processing unit 22 among the plurality of kinds of measurement information.

The acquisition unit 21 acquires the measurement information designated by the processing unit 22, and outputs the measurement information to the processing unit 22.

[Operation Flow]

Each of the devices in the control system according to the embodiment of the present disclosure includes a computer that includes a memory. An arithmetic processing unit such as a CPU in the computer reads out, from the memory, a program including a part or all of steps in the flowchart and sequence shown below, and executes the program. Programs for the devices can each be installed from outside. The programs for the devices are each distributed in a state of being stored in a recording medium or through a communication line.

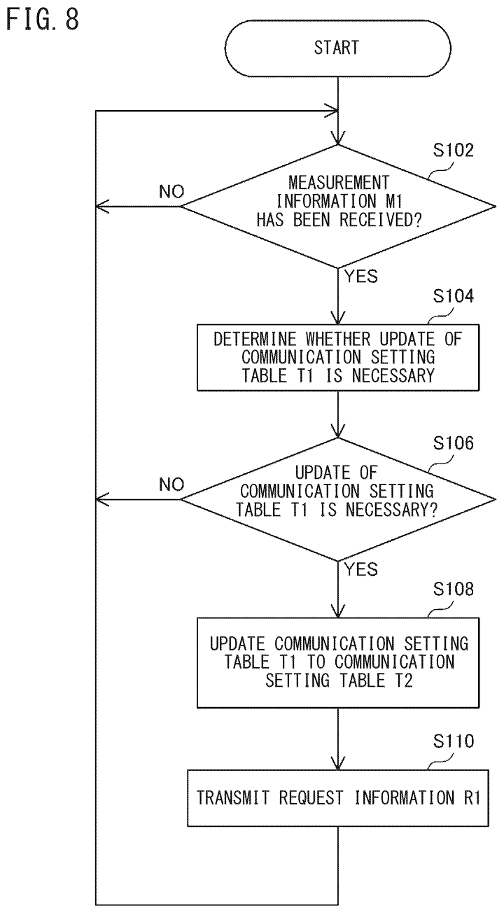

FIG. 8 is a flowchart showing an example of an operation procedure when the communication device according to the embodiment of the present disclosure performs transmission control. FIG. 8 shows the flowchart of processing of the communication device 101 in the specific example 1 of the transmission control.

With reference to FIG. 8, the communication device 101 waits for an IP packet including measurement information M1 (NO in step S102). Upon receiving an IP packet including measurement information M1 that indicates a viewing area from the measurement device 131 via the relay device 111 (YES in step S102), the communication device 101 determines whether or not update of the communication setting table T1 stored in the storage unit 15 is necessary, based on the measurement information M1 included in the received IP packet (step S104).

Upon determining that update of the communication setting table T1 is not necessary (NO in step S106), the communication device 101 waits for a new IP packet including measurement information M1 (NO in step S102).

Meanwhile, upon determining that update of the communication setting table T1 is necessary (YES in step S106), the communication device 101, as a transmission control, promotes relay of communication information related to the viewing area to the relay device 111 by the transfer unit 14. More specifically, the communication device 101 generates a new communication setting table T2 in which the priority level and data transfer rate of image information and the priority level and data transfer rate of sound information have been changed, and updates the communication setting table T1 in the storage unit 15 to the generated communication setting table T2 (step S108).

Next, the communication device 101, as a transmission control, promotes transmission of the communication information related to the viewing area to the communication device 101 by the communication device 201. More specifically, the communication device 101 generates request information R1 including the communication setting table T2, adds the generated request information R1 to an IP packet, and transmits the IP packet to the communication device 201 via the network 301 (step S110).

Next, the communication device 101 waits for a new IP packet including measurement information M1 (NO in step S102).

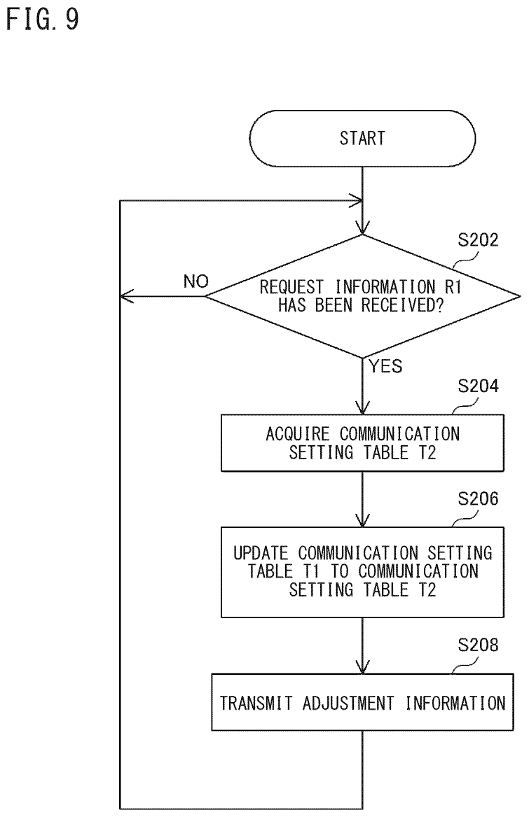

FIG. 9 is a flowchart showing an example of an operation procedure when the communication device according to the embodiment of the present disclosure performs transmission control. FIG. 9 shows a flowchart of processing of the communication device 201 in the specific example 1 of the transmission control described above.

With reference to FIG. 9, the communication device 201 waits for an IP packet including request information R1 (NO in step S202). Upon receiving an IP packet including request information R1 from the communication device 101 via the network 301 (YES in step S202), the communication device 201 acquires the communication setting table T2 from the request information R1 included in the received IP packet (step S204).

Next, the communication device 201 updates the communication setting table T1 stored in the storage unit 25 to the acquired communication setting table T2. Thus, transmission of the communication information related to the viewing area to the communication device 101 by the transfer unit 24 is promoted, and transmission of the communication information related to the area other than the viewing area to the communication device 101 by the transfer unit 24 is inhibited (step S206).

Next, regarding the communication information in which the priority level and the data transfer rate have been changed due to the update of the communication setting table T1 to the communication setting table T2, the communication device 201 generates adjustment information including the changed priority level and data transfer rate, adds the generated adjustment information to an IP packet, and transmits the IP packet to the device that is the transmission source of the communication information (step S208).

Next, the communication device 201 waits for a new IP packet including request information R1 (NO in step S202).

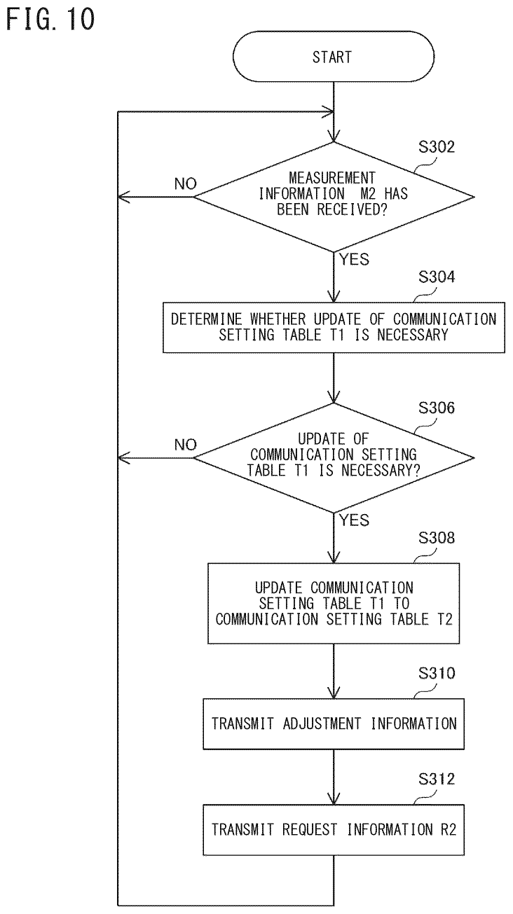

FIG. 10 is a flowchart showing another example of the operation procedure when the communication device according to the embodiment of the present disclosure performs the transmission control. FIG. 10 shows a flowchart of processing of the communication device 201 in the specific example 2 of the transmission control.

With reference to FIG. 10, the communication device 201 waits for an IP packet including measurement information M2 (NO in step S302). Upon receiving an IP packet including measurement information M2 indicating an object area from the management device 221 via the relay device 211 (YES in step S302), the communication device 201 determines whether or not update of the communication setting table T1 in the storage unit 15 is necessary, based on the measurement information M2 included in the received IP packet (step S304).

Next, upon determining that update of the communication setting table T1 is not necessary (NO in step S306), the communication device 201 waits for a new IP packet including measurement information M2 (NO in step S302).

Meanwhile, upon determining that update of the communication setting table T1 is necessary (YES in step S306), the communication device 201, as a transmission control, promotes transmission of the communication information related to the object area to the communication device 101 by the transfer unit 24 itself. More specifically, the communication device 201 generates a new communication setting table T2 in which the priority level and data transfer rate of the image information and the priority level and data transfer rate of the sound information have been changed, and updates the communication setting table T1 in the storage unit 25 to the generated communication setting table T2 (step S308).

Next, the communication device 201, as a transmission control, adjusts the amount of the communication information, related to the object area, to be generated by the camera module 241 and the microphone module 251. More specifically, regarding the communication information in which the priority level and the data transfer rate have been changed due to the update of the communication setting table T1 to the communication setting table T2, the communication device 201 generates adjustment information including the changed priority level and data transfer rate, adds the generated adjustment information to the IP packet, and transmits the IP packet to the camera module 241 and the microphone module 251 (step S310).

Next, the communication device 201, as a transmission control, promotes relay of the communication information related to the object area to the relay device 111 by the communication device 101. More specifically, the communication device 201 generates request information R2 including the communication setting table T2, adds the generated request information R2 to an IP packet, and transmits the IP packet to the communication device 101 via the network 301 (step S312).

Next, the communication device 201 waits for a new IP packet including measurement information M2 (NO in step S302).

The order of steps S310 and S312 is not limited to the above order, and the order may be switched.

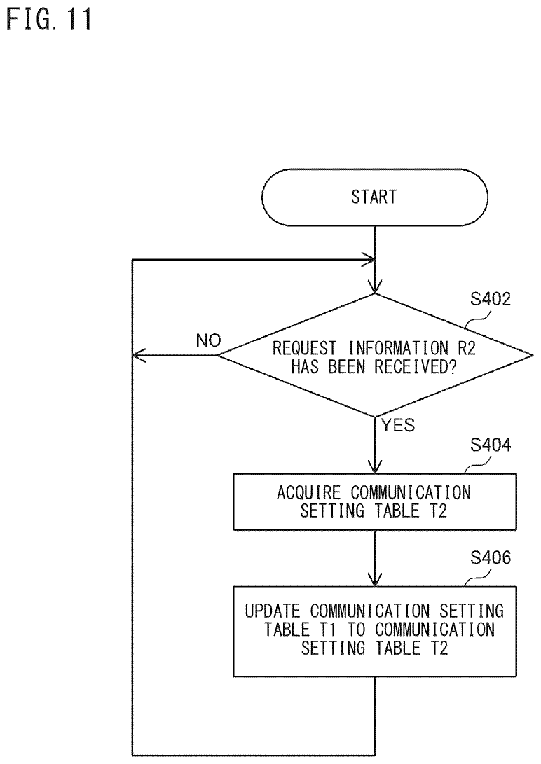

FIG. 11 is a flowchart showing an example of an operation procedure when the communication device according to the embodiment of the present disclosure performs transmission control. FIG. 11 shows a flowchart of processing of the communication device 101 in the specific example 2 of the transmission control described above.

With reference to FIG. 11, the communication device 101 waits for an IP packet including request information R2 (NO in step S402). Upon receiving an IP packet including request information R2 from the communication device 201 via the network 301 (YES in step S402), the communication device 101 acquires the communication setting table T2 from the request information R2 included in the received IP packet (step S404).

Next, the communication device 101 updates the communication setting table T1 in the storage unit 15 to the acquired communication setting table T2. Thus, relay of the communication information related to the object area to the relay device 111 by the transfer unit 14 itself is promoted, and relay of the communication information related to the area other than the object area to the relay device 111 by the transfer unit 14 itself is inhibited (S406).

Next, the communication device 101 waits for a new IP packet including request information R2 (NO in step S402).

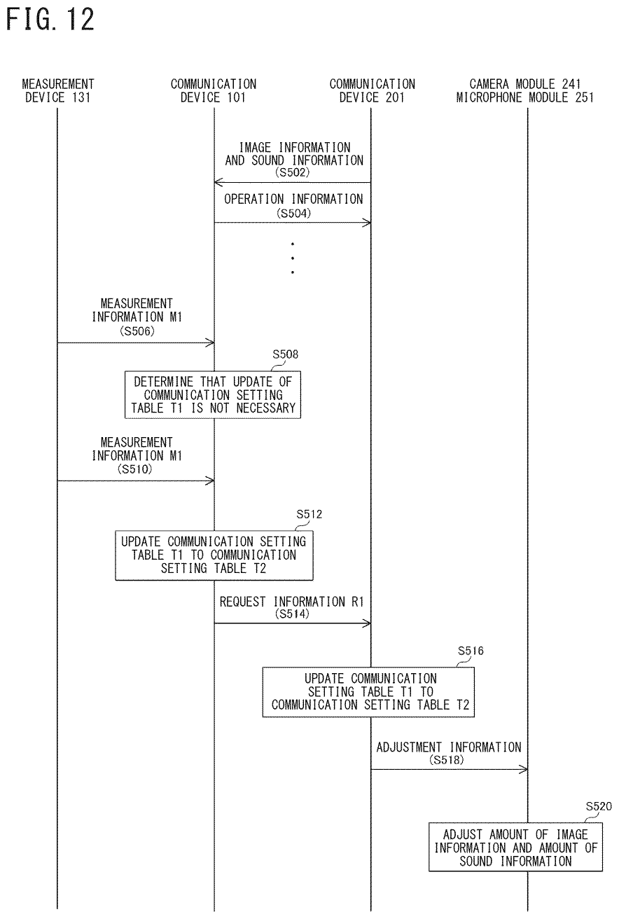

FIG. 12 shows an example of a sequence of transmission control in the control system according to the embodiment of the present disclosure. FIG. 12 shows the sequence of the specific example 1 of the transmission control described above.

With reference to FIG. 12, first, the communication device 201, for example, periodically transmits an IP packet containing image information and sound information to the communication device 101 via the network 301 (step S502).

In addition, the communication device 101, for example, periodically transmits an IP packet containing operation information to the communication device 201 via the network 301 (step S504).

Next, the measurement device 131 detects an area forward of the vehicle 2 as a viewing area, adds measurement information M1 indicating the detected viewing area to an IP packet, and transmits the IP packet to the communication device 101 (step S506).

Next, the communication device 101 acquires the measurement information M1 from the IP packet received from the measurement device 131. Based on the acquired measurement information M1, the communication device 101 determines that the operator pays attention to the area forward of the vehicle 2, and determines that update of the communication setting table T1 in the storage unit 15 is not necessary (step S508).

Next, the measurement device 131 detects an area on the right side of the vehicle 2 as a viewing area, adds measurement information M1 indicating the detected viewing area to an IP packet, and transmits the IP packet to the communication device 101 (step S510).

Next, the communication device 101 acquires the measurement information M1 from the IP packet received from the measurement device 131. Based on the acquired measurement information M1, the communication device 101 determines that the operator pays attention to the area on the right side of the vehicle 2, and determines that update of the communication setting table T1 in the storage unit 15 is necessary. Then, the communication device 101 generates a communication setting table T2, and updates the communication setting table T1 in the storage unit 15 to the generated communication setting table T2. Thus, relay of the communication information related to the viewing area to the relay device 111 by the transfer unit 14 is promoted, and relay of the communication information related to the area other than the viewing area to the relay device 111 by the transfer unit 14 is inhibited (step S512).

Next, the communication device 101 generates request information R1 including the communication setting table T2, adds the generated request information R1 to an IP packet, and transmits the IP packet to the communication device 201 via the network 301 (step S514).

Next, the communication device 201 acquires the request information R1 from the IP packet received from the communication device 101 via the network 301, and acquires the communication setting table T2 from the request information R1. Then, the communication device 201 updates the communication setting table T1 in the storage unit 25 to the acquired communication setting table T2. Thus, transmission of the communication information related to the viewing area to the communication device 101 by the transfer unit 24 itself is promoted, and transmission of the communication information related to the area other than the viewing area to the communication device 101 by the transfer unit 24 itself is inhibited (step S516).

Next, the communication device 201 generates adjustment information including the changed priority level and data transfer rate, adds the generated adjustment information to an IP packet, and transmits the IP packet to the camera module 241 and the microphone module 251 (step S518).

Next, the camera module 241 and the microphone module 251 each acquire the adjustment information from the IP packet received from the communication device 201, and adjust the amounts of image information and sound information to be generated, based on the acquired adjustment information (step S520).

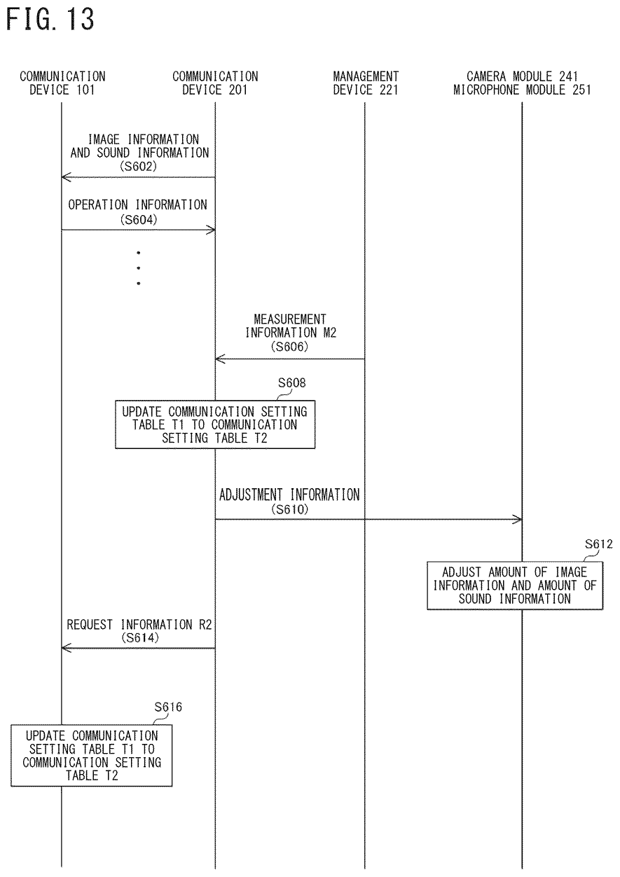

FIG. 13 shows another example of a sequence of transmission control in the control system according to the embodiment of the present disclosure. FIG. 13 shows the sequence of the specific example 2 of the transmission control described above.

With reference to FIG. 13, first, the communication device 201, for example, periodically transmits an IP packet containing image information and sound information to the communication device 101 via the network 301 (step S602).

In addition, the communication device 101, for example, periodically transmits an IP packet containing operation information to the communication device 201 via the network 301 (step S604).

Next, the management device 221 detects an area on the right side of the vehicle 2 as an object area, adds measurement information M2 indicating the detected object area to an IP packet, and transmits the IP packet to the communication device 201 (step S606).

Next, the communication device 201 acquires the measurement information M2 from the IP packet received from the management device 221. Based on the acquired measurement information M2, the communication device 201 determines that the area to which the operator should pay attention is the area on the right side of the vehicle 2, and determines that update of the communication setting table T1 in the storage unit 25 is necessary. Then, the communication device 201 generates a communication setting table T2, and updates the communication setting table T1 in the storage unit 25 to the generated communication setting table T2. Thus, transmission of the communication information related to the object area to the communication device 101 by the transfer unit 24 itself is promoted, and transmission of the communication information related to the area other than the object area to the communication device 101 by the transfer unit 24 itself is inhibited (step S608).

Next, the communication device 201 generates adjustment information including the changed priority level and data transfer rate, adds the generated adjustment information to an IP packet, and transmits the IP packet to the camera module 241 and the microphone module 251 (step S610).

Next, the camera module 241 and the microphone module 251 each acquire the adjustment information from the IP packet received from the communication device 201, and adjust the amounts of image information and sound information to be generated, based on the acquired adjustment information (step S612).

Next, the communication device 201 generates request information R2 including the communication setting table T2, adds the generated request information R2 to an IP packet, and transmits the IP packet to the communication device 101 via the network 301 (step S614).

Next, the communication device 101 acquires the request information R2 from the IP packet received from the communication device 201 via the network 301, and acquires the communication setting table T2 from the request information R2. Then, the communication device 101 updates the communication setting table T1 in the storage unit 15 to the acquired communication setting table T2. Thus, relay of the communication information related to the object area to the relay device 111 by the transfer unit 14 is promoted, and relay of the communication information related to the area other than the object area to the relay device 111 by the transfer unit 14 is inhibited (step S616).

In the communication device 101 according to the embodiment of the present disclosure, the transmission control by the processing unit 12 includes the control for promoting transmission of the communication information related to the viewing area by the transfer unit 14. However, the transmission control is not limited thereto. The transmission control by the processing unit 12 may not necessarily include the control for promoting transmission of the communication information related to the viewing area by the transfer unit 14, and may include a control for promoting transmission of communication information not related to the viewing area by the transfer unit 14. For example, the transmission control by the processing unit 12 may include a control for promoting transmission of the operation information by the transfer unit 14. More specifically, the processing unit 12 determines to change the priority level and data transfer rate of the operation information, generates the communication setting table in which the details of the determined changes are reflected, and updates the communication setting table T1 in the storage unit 15 to the generated communication setting table.

In the communication device 201 according to the embodiment of the present disclosure, the transmission control by the processing unit 22 includes the control for promoting transmission of the communication information related to the object area by the transfer unit 24. However, the transmission control is not limited thereto. The transmission control by the processing unit 22 may not necessarily include the control for promoting transmission of the communication information related to the object area by the transfer unit 24, and may include a control for promoting transmission of communication information not related to the object area by the transfer unit 24. For example, the transmission control by the processing unit 22 may include a control for promoting transmission of operation information by the transfer unit 24. More specifically, the processing unit 22 determines to change the priority level and data transfer rate of the operation information, generates a communication setting table in which the details of the determined changes are reflected, and transmits request information including the generated communication setting table to the communication device 101 via the request transmission reception unit 23 and the network 301.

In the communication device 101 according to the embodiment of the present disclosure, the transmission control by the processing unit 12 includes both the control for promoting relay of the communication information related to the viewing area to the relay device 111 by the transfer unit 14, and the control for promoting transmission of the communication information related to the viewing area to the communication device 101 by the communication device 201. However, the transmission control is not limited thereto. The transmission control by the processing unit 12 may not necessarily include one of the control for promoting relay of the communication information related to the viewing area to the relay device 111 by the transfer unit 14, and the control for promoting transmission of the communication information related to the viewing area to the communication device 101 by the communication device 201. That is, the processing unit 12 may not necessarily perform one of update of the communication setting table T1 in the storage unit 15, and generation of the request information R1.

In the communication device 201 according to the embodiment of the present disclosure, the transmission control by the processing unit 22 includes both the control for promoting transmission of the communication information related to the object area to the communication device 101 by the transfer unit 24 itself, and the control for adjusting the amount of the communication information, related to the object area, to be generated by the camera module 241 and the microphone module 251. However, the transmission control is not limited thereto. The transmission control by the processing unit 22 may not necessarily include one of the control for promoting transmission of the communication information related to the object area to the communication device 101 by the transfer unit 24 itself, and the control for adjusting the amount of the communication information, related to the object area, to be generated by the camera module 241 and the microphone module 251. That is, the processing unit 22 may not necessarily perform one of update of the communication setting table T1 in the storage unit 25, and generation of the adjustment information.

In the communication device 101 according to the embodiment of the present disclosure, the processing unit 12 generates the request information R1 including the communication setting table T2. However, the processing unit 12 is not limited thereto. The processing unit 12 may generate the request information R1 that indicates the change in the priority level of the communication information and the change in the data transfer rate of the communication information, while including no communication setting table T2. Likewise, the processing unit 22 in the communication device 201 may generate the request information R2 that indicates the change in the priority level of the communication information and the change in the data transfer rate of the communication information, while including no communication setting table T2.

In the communication device 101 according to the embodiment of the present disclosure, the processing unit 12 determines whether or not update of the communication setting table T1 is necessary, and generates the communication setting table T2. However, the processing unit 12 is not limited thereto. The processing unit 12 may transmit the measurement information M1 to a server (not shown) outside the communication device 101, and acquire, from the server, the communication setting table T2, and a determination result as to whether update of the communication setting table T1 is necessary. Likewise, the processing unit 22 in the communication device 201 may transmit the measurement information M2 to a server (not shown) outside the communication device 201, and acquire, from the server, the communication setting table T2, and a determination result as to whether update of the communication setting table T1 is necessary. In addition, the software of the processing units 12, 22 may be updated by the server (not shown).

Meanwhile, a technology enabling highly real-time communication has been desired. More specifically, with an increase in communication speed in recent years, highly real-time, stable communication with reduced communication delay has been desired. For example, technologies such as DiffServ (Differentiated Services) type QoS (Quality of Service), IntServ type QoS, and centralized QoS are known as IP packet priority control in a wide area IP network. With these technologies, however, a delay may occur in the arrival time of an IP packet to a destination device, which makes it difficult to realize highly real-time communication.

Meanwhile, in the communication device 101 according to the embodiment of the present disclosure, the transfer unit 14 performs, with the communication device 201, at least one of transmission and reception of communication information to be used for control of the vehicle 2, via the network 301. The acquisition unit 11 acquires measurement information M1 based on a measurement result related to the operator. Based on the measurement information M1 acquired by the acquisition unit 11, the processing unit 12 performs transmission control being a control related to transmission of the communication information by the transfer unit 14.

As described above, since the transmission control for the communication information to be used for control of the vehicle 2 is performed based on the measurement information M1 based on the measurement result related to the operator, the transmission control for the communication information can be precisely and flexibly performed according to the state of the operator. Therefore, for example, by selectively or preferentially transmitting communication information that is highly important for the operator among plural pieces of communication information, a communication delay of the communication information highly important for the operator can be inhibited. Therefore, the communication device 101 according to the embodiment of the present disclosure can realize highly real-time communication. Specifically, the control system 501 that allows the operator to control the vehicle 2 without discomfort can be realized. In addition, by discarding less important communication information while selectively or preferentially transmitting highly important communication information, communication traffic in the control system 501 can be reduced.

The above embodiment is merely illustrative in all aspects and should not be recognized as being restrictive. The scope of the present disclosure is defined by the scope of the claims rather than by the description above, and is intended to include meaning equivalent to the scope of the claims and all modifications within the scope.

The processes (functions) of the above-described embodiment may be realized by processing circuitry including one or more processors. In addition to the one or more processors, the processing circuit may include an integrated circuit or the like in which one or more memories, various analog circuits, and various digital circuits are combined. The one or more memories have, stored therein, programs (instructions) that cause the one or more processors to execute the processes. The one or more processors may execute the processes according to the program read out from the one or more memories, or may execute the processes according to a logic circuit designed in advance to execute the processes. The above processors may include a CPU (Central Processing Unit), a GPU (Graphics Processing Unit), a DSP (Digital Signal Processor), an FPGA (Field Programmable Gate Array), an ASIC (Application Specific Integrated Circuit), etc., which are compatible with computer control. The physically separated processors may execute the processes in cooperation with each other. For example, the processors installed in physically separated computers may execute the processes in cooperation with each other through a network such as a LAN (Local Area Network), a WAN (Wide Area Network), or the Internet. The program may be installed in the memory from an external server device or the like through the network. Alternatively, the program may be distributed in a state of being stored in a recording medium such as a CD-ROM (Compact Disc Read Only Memory), a DVD-ROM (Digital Versatile Disk Read Only Memory), or a semiconductor memory, and may be installed in the memory from the recording medium.

The above description includes the features in the additional notes below.

### Additional Note 1

A communication device provided outside a control target to be controlled by a control subject, the communication device comprising:
a communication unit configured to perform, through a network, at least one of transmission and reception of communication information to be used for control of the control target, with a communication target device provided in the control target;
an acquisition unit configured to acquire measurement information based on a measurement result related to the control subject; and
a communication control unit configured to perform a transmission control for the communication information by the communication unit, based on the measurement information acquired by the acquisition unit, wherein
the acquisition unit acquires the measurement information indicating an area of interest being an area to which the control subject pays attention, among areas around the control target, the area of interest being determined based on a detection result of a line of sight of the control target.

### Additional Note 2

A communication device provided in a control target to be controlled by a control subject, the communication device comprising:
a communication unit configured to perform, through a network, at least one of transmission and reception of communication information to be used for control of the control target, with a communication target device provided outside the control target;
an acquisition unit configured to acquire measurement information based on a measurement result related to the control target; and
a communication control unit configured to perform a transmission control for the communication information by the communication unit, based on the measurement information acquired by the acquisition unit, wherein
the acquisition unit acquires the measurement information indicating an area of interest being an area to which the control subject should pay attention, among areas around the control target, the area of interest being determined based on a detection result of an object present in the areas around the control target.

### Additional Note 3

A communication device provided outside a control target to be controlled by a control subject, the communication device comprising a processing circuit,
the processing circuit configured to:
perform, through a network, at least one of transmission and reception of communication information to be used for control of the control target, with a communication target device provided in the control target;
acquire measurement information based on a measurement result related to the control subject; and
perform a transmission control being a control related to transmission of the communication information, based on the acquired measurement information.

### Additional Note 4

A communication device provided in a control target to be controlled by a control subject, the communication device comprising a processing circuit,
the processing circuit configured to:
perform, through a network, at least one of transmission and reception of communication information to be used for control of the control target, with a communication target device provided outside the control target;
acquire measurement information based on a measurement result related to the control target; and
perform a transmission control being a control related to transmission of the communication information, based on the acquired measurement information.

### REFERENCE SIGNS LIST

1 control center
2 vehicle
11 acquisition unit
12 processing unit
13 request transmission reception unit
14 transfer unit
15 storage unit
21 acquisition unit
22 processing unit
23 request transmission reception unit
24 transfer unit
25 storage unit
101 communication device
111 relay device
121 operation device
131 measurement device
141A, 141B, 141C, 141 display processing device
151 reproduction processing device
201 communication device
211 relay device
221 management device
231 driving device
241A, 241B, 241C, 241 camera module
251A, 251B, 251C, 251 microphone module
301 network
501 control system
T, T1, T2 communication setting table

1. A communication device provided outside a control target to be controlled by a control subject, the communication device comprising:
a communication unit configured to perform, through a network, at least one of transmission and reception of communication information to be used for control of the control target, with a communication target device provided in the control target;
an acquisition unit configured to acquire measurement information based on a measurement result related to the control subject; and
a communication control unit configured to perform a transmission control being a control related to transmission of the communication information by the communication unit, based on the measurement information acquired by the acquisition unit.

2. The communication device according to claim 1, wherein
the acquisition unit acquires the measurement information indicating an area of interest being an area to which the control subject pays attention, among areas around the control target, and
the transmission control includes a control for promoting transmission of the communication information related to the area of interest by the communication unit.

3. The communication device according to claim 2, wherein
the communication unit relays the communication information received from the communication target device to another device provided on a side where the control subject is present with respect to the network, and
the transmission control includes a control for promoting relay of the communication information related to the area of interest, to the other device by the communication unit.

4. The communication device according to claim 2, wherein
the transmission control includes a control for promoting transmission of the communication information related to the area of interest, to the communication device by the communication target device.

5. A communication device provided in a control target to be controlled by a control subject, the communication device comprising:
a communication unit configured to perform, through a network, at least one of transmission and reception of communication information to be used for control of the control target, with a communication target device provided outside the control target;
an acquisition unit configured to acquire measurement information based on a measurement result related to the control target; and
a communication control unit configured to perform a transmission control being a control related to transmission of the communication information by the communication unit, based on the measurement information acquired by the acquisition unit.

6. The communication device according to claim 5, wherein
the acquisition unit acquires the measurement information indicating an area of interest being an area to which the control subject should pay attention, among areas around the control target, and
the transmission control includes a control for promoting transmission of the communication information related to the area of interest, to the communication target device by the communication unit.

7. The communication device according to claim 6, wherein
the communication unit transmits, to the communication target device, the communication information generated by another device provided in the control target, and
the transmission control includes a control for promoting transmission of the communication information related to the area of interest, to the communication target device by the communication unit itself.

8. The communication device according to claim 6, wherein
the communication unit transmits, to the communication target device, the communication information generated by another device provided in the control target, and
the transmission control includes a control for adjusting the amount of the communication information, related to the area of interest, to be generated by the other device.

9. A control system, comprising:
a first communication device provided outside a control target to be controlled by a control subject; and
a second communication device provided in the control target, wherein
the first communication device and the second communication device exchange communication information to be used for control of the control target, through a network,
the first communication device performs a transmission control being a control related to transmission of the communication information with the second communication device, based on first measurement information indicating a measurement result related to the control subject, and
the second communication device performs a transmission control being a control related to transmission of the communication information with the first communication device, based on second measurement information indicating a measurement result related to the control target.

10.-11. (canceled)

12. A non-transitory computer readable storage medium storing a communication program used in a communication device provided outside a control target to be controlled by a control subject,
the program causing a computer to function as:
a communication unit configured to perform, through a network, at least one of transmission and reception of communication information to be used for control of the control target, with a communication target device provided in the control target;
an acquisition unit configured to acquire measurement information based on a measurement result related to the control subject; and
a communication control unit configured to perform a transmission control being a control related to transmission of the communication information by the communication unit, based on the measurement information acquired by the acquisition unit.

13. A non-transitory computer readable storage medium storing a communication program used in a communication device provided in a control target to be controlled by a control subject,
the program causing a computer to function as:
a communication unit configured to perform, through a network, at least one of transmission and reception of communication information to be used for control of the control target, with a communication target device provided outside the control target;
an acquisition unit configured to acquire measurement information based on a measurement result related to the control target; and
a communication control unit configured to perform a transmission control being a control related to transmission of the communication information by the communication unit, based on the measurement information acquired by the acquisition unit.

14. The communication device according to claim 3, wherein
the transmission control includes a control for promoting transmission of the communication information related to the area of interest, to the communication device by the communication target device.

15. The communication device according to claim 7, wherein
the communication unit transmits, to the communication target device, the communication information generated by another device provided in the control target, and
the transmission control includes a control for adjusting the amount of the communication information, related to the area of interest, to be generated by the other device.

16. The communication device according to claim 1, wherein
the acquisition unit acquires the measurement information indicating an area of interest being an area to which the control subject pays attention, among areas around the control target, the area of interest being determined based on a detection result of a line of sight of the control subject.

17. The communication device according to claim 1, wherein
the communication unit transmits the communication information according to a communication setting table for the transmission control, and
the communication control unit updates the communication setting table based on the measurement information acquired by the acquisition unit.

18. The communication device according to claim 17, wherein
the communication control unit transmits request information including the updated communication setting table to the communication target device in order to update a communication setting table of the communication target device.

19. The communication device according to claim 5, wherein
the acquisition unit acquires the measurement information indicating an area of interest being an area to which the control subject should pay attention, among areas around the control target, the area of interest being determined based on a detection result of an object present in the areas around the control target.

20. The communication device according to claim 5, wherein
the communication unit transmits the communication information according to a communication setting table for the transmission control, and
the communication control unit updates the communication setting table based on the measurement information acquired by the acquisition unit.

21. The communication device according to claim 20, wherein
the communication control unit transmits request information including the updated communication setting table to the communication target device in order to update a communication setting table of the communication target device.
